(19) United States
(12) Patent Application Publication
(10) Pub. No.: US 2019/0164164 A1
(43) Pub. Date: May 30, 2019

(54) COLLABORATIVE PATTERN RECOGNITION SYSTEM

(71) Applicant: Krishna Pasupathy Karambakkam, San Jose, CA (US)

(72) Inventor: Krishna Pasupathy Karambakkam, San Jose, CA (US)

(21) Appl. No.: 16/172,751

(22) Filed: Oct. 27, 2018

Related U.S. Application Data
(60) Provisional application No. 62/578,317, filed on Oct. 27, 2017.
(60) Provisional application No. 62/567,127, filed on Oct. 2, 2017.

(51) Int. Cl. G06Q 20/40; G06K 9/62; G06N 5/04; G06N 3/08

(52) U.S. Cl. CPC G06Q 20/4016; G06K 9/6263; G06N 3/08; G06N 5/043; G06K 9/6218

(57) ABSTRACT

Apparatus and associated methods relate to a pattern recognition system configured to classify a transaction as anomalous or not anomalous as a function of a predictive analytic model configured to detect anomalies, generate a rule based on expert analysis of a limited number of data samples to classify as anomalous a transaction erroneously classified as not anomalous, augment the predictive analytic model with the generated rule, and deploy the augmented predictive analytic model to automatically identify an attack early in a live transaction stream. In some examples, the transaction may be a bank card purchase. Some transactions may be classified anomalous due to fraud, compliance violation such as money laundering, or terrorist funding. The predictive analytic model may be, for example, a decision tree followed by a regression model. Various embodiments may advantageously generate rules based on transaction criteria selected by human experts exploring and manipulating visually perceptible transaction representations.

### CROSS-REFERENCE TO RELATED APPLICATIONS

This application claims the benefit of U.S. Provisional Application No. 62/578,317, titled “Collaborative Pattern Recognition System Version2,” filed by Krishna Pasupathy Karambakkam, on Oct. 27, 2017.

This application also claims the benefit of U.S. Provisional Application No. 62/567,127, titled “Collaborative Pattern Recognition System,” filed by Krishna Pasupathy Karambakkam, on Oct. 2, 2017.

This application incorporates the entire contents of the above-referenced applications herein by reference.

### TECHNICAL FIELD

Various embodiments relate generally to pattern recognition.

### BACKGROUND

Transactions are an exchange. Some transactions include an exchange of goods or services. Goods or services may be exchanged for monetary value in a financial transaction. For example, a purchase transaction may include bank card payment for an airline ticket. In an illustrative example, a financial institution may attempt to validate a bank card payment before exchanging the good or service for the payment.

In some examples, a financial institution may attempt to validate a proposed transaction based on comparing the proposed transaction with previous transactions. A proposed transaction having characteristics similar to typical transactions may be allowed. In various scenarios, a proposed transaction having a characteristic different from typical transactions may be classified as anomalous. In an illustrative example, transaction characteristics may include various features of the parties in the transaction and the payment service, such as, for example, location, the type of product, payment account type, purchase price, or the length of time the payment service has been in operation. In some examples, an anomalous transaction may be declined, or flagged for further study by an expert analyst.

Some allowed transactions may be fraudulent. In various scenarios, a fraudulent transaction may be completed without detection, if the transaction is not identified as anomalous. In various examples, a fraudulent transaction may not be detected until significant time has passed after the transaction. In an illustrative example, fraud may not be detected until a bank card customer reviews their bank account statement. Some fraud perpetrators may avoid detection based on rapidly changing their fraudulent transaction characteristics. In some examples, fraud perpetrators may change their fraudulent transaction characteristics before fraud is detected by a bank card customer reviewing their account statement.

### SUMMARY

Apparatus and associated methods relate to a pattern recognition system configured to classify a transaction as anomalous or not anomalous as a function of a predictive analytic model configured to detect anomalies, generate a rule based on expert analysis of a limited number of data samples to classify as anomalous a transaction erroneously classified as not anomalous, augment the predictive analytic model with the generated rule, and deploy the augmented predictive analytic model to automatically identify an attack early in a live transaction stream. In some examples, the transaction may be a bank card purchase. Some transactions may be classified anomalous due to fraud, compliance violation such as money laundering, or terrorist funding. The predictive analytic model may be, for example, a decision tree followed by a regression model. Various embodiments may advantageously generate rules based on transaction criteria selected by human experts exploring and manipulating visually perceptible transaction representations.

Various embodiments may achieve one or more advantages. For example, some embodiments may reduce the time required to detect an attack. This facilitation may be a result of identifying an attack early using a limited number of samples. Various examples may increase the probability a new attack vector will be detected early. Such increased probability of new attack vector detection may be a result of increasing the rate at which an anomaly detection system can be adapted to detect a new attack vector, reducing the user's time waiting for attack victims to report the attack. In some embodiments, the probability of early fraud detection may be increased. Such increased early fraud detection probability may be a result of monitoring a live transaction stream with a predictive analytic model augmented with rules generated by an expert analyst to detect anomalous transactions. Various examples may reduce a financial service user's exposure to fraud. This facilitation may be a result of detecting fraud early using a limited number of data samples identified by a rule generated based on variables selected by an expert analyst. Some embodiments may reduce an expert analyst's effort related to identifying anomalous transactions. Such reduced expert analyst effort may be a result of visually perceptible transaction models presented to the analyst.

Some embodiments may enhance the accuracy of anomaly detection. This facilitation may be a result of providing an expert analyst with a graphical interface configured to visually model and explore transactions suspicious to the expert analyst. Various examples may reduce a user's exposure to financial loss. Such reduced financial loss exposure may be a result of detecting anomalous transactions as fraud early, soon after an expert analyst creates a predictive analytic model encoding a rule generated to detect the anomaly based on variables selected by the analyst using a transaction visualization and modeling system. In an illustrative example, a predictive analytic model augmented based on such expert analyst insight may detect fraud long before methodologies requiring waiting one to six weeks for victim card holders to report fraud after receiving their account statement. In some embodiments, compliance violations may be detected early enough to prevent money laundering or terrorist funding. Such early compliance violation detection may be a result of detecting anomalous transactions with a predictive analytic model customized by an expert analyst to identify money laundering, terrorist financing, or any high-risk scenario identifiable by the analyst.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary pattern recognition system configured to classify a transaction as anomalous or not anomalous as a function of a predictive analytic model configured to detect anomalies, generate a rule based on expert analysis of a limited number of data samples to classify as anomalous a transaction erroneously classified as not anomalous, augment the predictive analytic model with the generated rule, and deploy the augmented predictive analytic model to automatically identify an attack early in a live transaction stream.

FIG. 2 depicts a schematic view of an exemplary collaborative anomaly detection network configured to classify a transaction as anomalous or not anomalous as a function of a predictive analytic model configured to detect anomalies, generate a rule based on expert analysis of a limited number of data samples to classify as anomalous a transaction erroneously classified as not anomalous, augment the predictive analytic model with the generated rule, and deploy the augmented predictive analytic model to automatically identify an attack early in a live transaction stream.

FIG. 3 depicts a structural view of an exemplary pattern recognition system configured to classify a transaction as anomalous or not anomalous.

FIG. 4 depicts a structural view of an exemplary anomalous transaction visualization and modeling system configured to create visually perceptible transaction models and present the models for analysis and manipulation by a human analyst expert.

FIG. 5 depicts a process flow of an exemplary CPRE (Collaborative Pattern Recognition Engine) configured to identify an attack early using a limited number of data samples.

FIG. 6 depicts a process flow of an exemplary ATMVE (Anomalous Transaction Modeling and Visualization Engine) configured to create visually perceptible transaction models and present the models for analysis and manipulation by a human analyst expert.

FIG. 7 depicts a screen capture view of an exemplary ATMVE (Anomalous Transaction Modeling and Visualization Engine) user interface operational scenario illustrating exemplary variable query construction.

FIG. 8 depicts a screen capture view of an exemplary ATMVE (Anomalous Transaction Modeling and Visualization Engine) user interface operational scenario illustrating exemplary variable performance evaluation.

FIG. 9 depicts a screen capture view of an exemplary ATMVE (Anomalous Transaction Modeling and Visualization Engine) user interface operational scenario illustrating an alternative variable query construction example.

FIG. 10 depicts a screen capture view of an exemplary ATMVE (Anomalous Transaction Modeling and Visualization Engine) user interface operational scenario illustrating exemplary rule construction.

FIG. 11 depicts a screen capture view of an exemplary ATMVE (Anomalous Transaction Modeling and Visualization Engine) user interface operational scenario illustrating an exemplary model constructed as a function of candidate variables selected by an agent.

FIG. 12 depicts a screen capture view of an exemplary ATMVE (Anomalous Transaction Modeling and Visualization Engine) user interface operational scenario illustrating an exemplary payment account profile.

FIG. 13 depicts a screen capture view of an exemplary ATMVE (Anomalous Transaction Modeling and Visualization Engine) user interface operational scenario illustrating an exemplary decision tree constructed as a function of candidate variables selected by an agent.

FIG. 14 depicts a structural view of an exemplary collaborative anomaly detection system design.

FIG. 15 depicts a data flow view of an exemplary visualization and modeling system variable selection interface design.

Like reference symbols in the various drawings indicate like elements.

### DETAILED DESCRIPTION OF ILLUSTRATIVE EMBODIMENTS

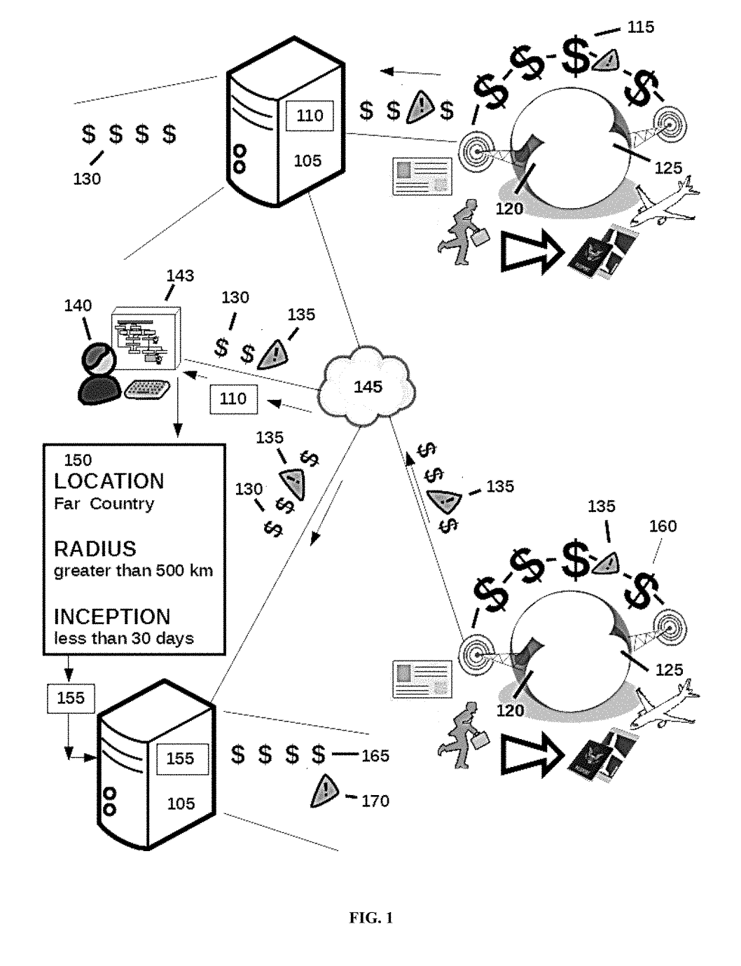

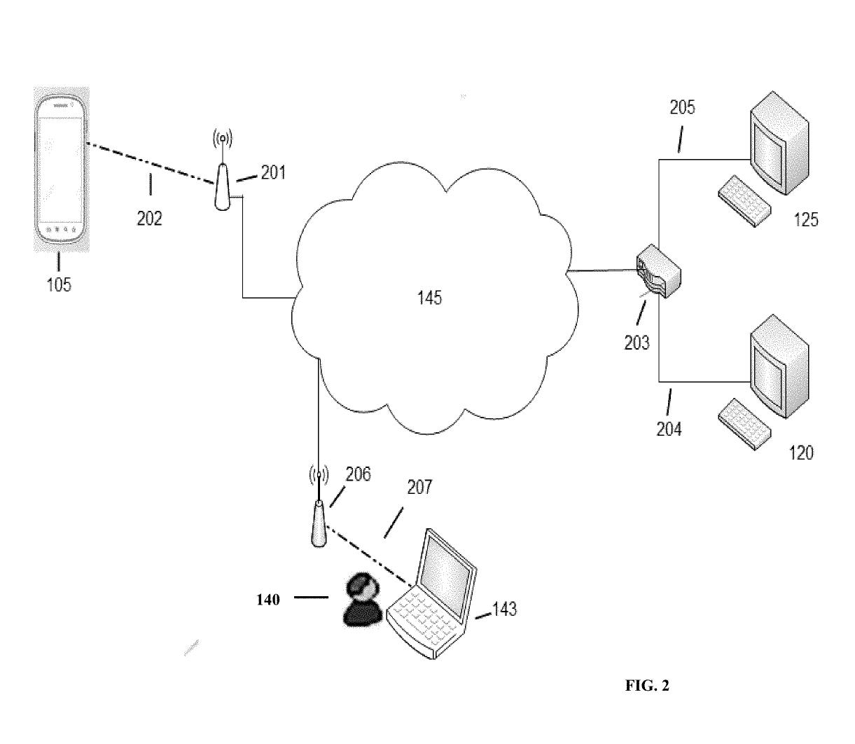

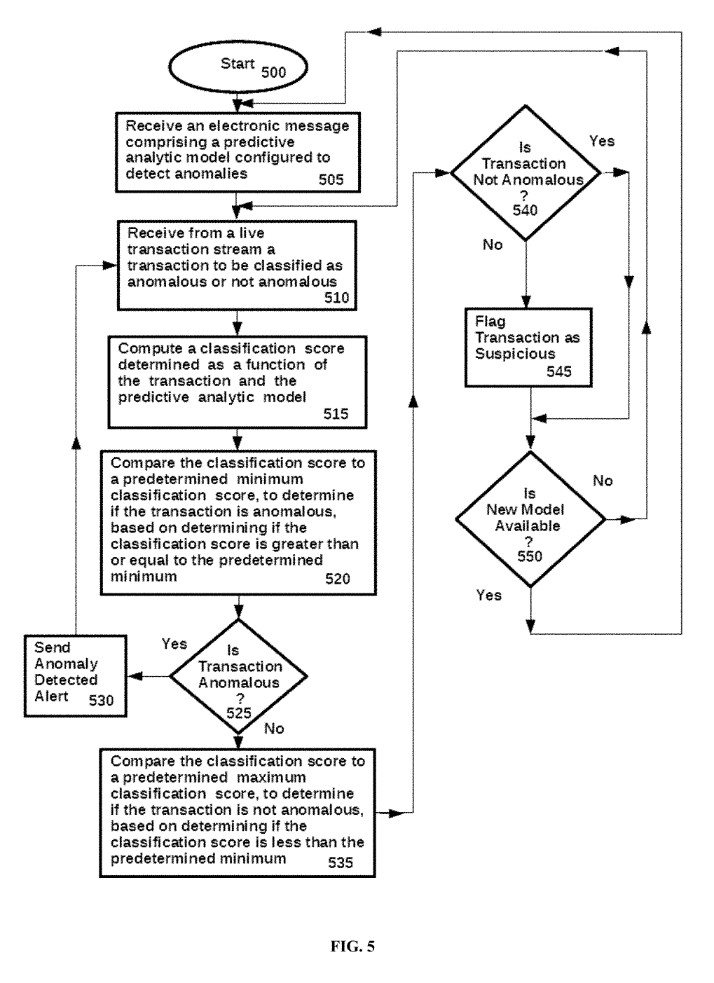

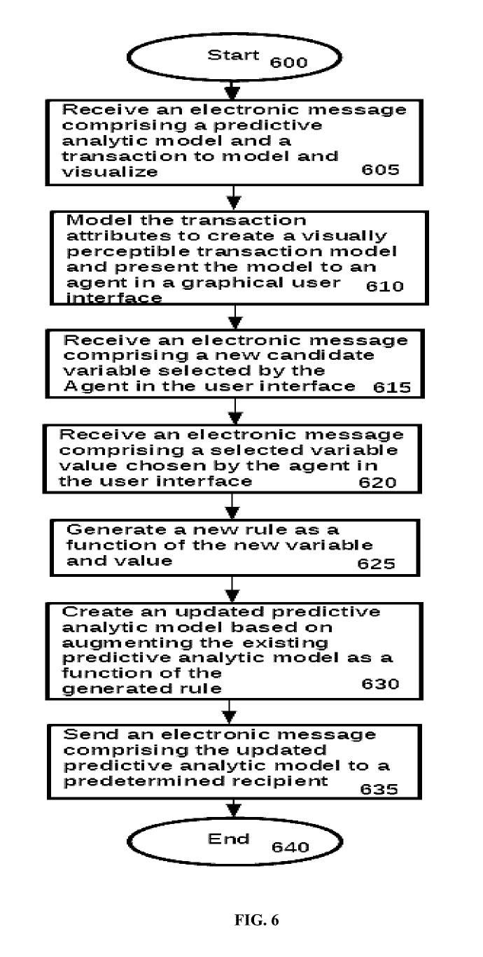

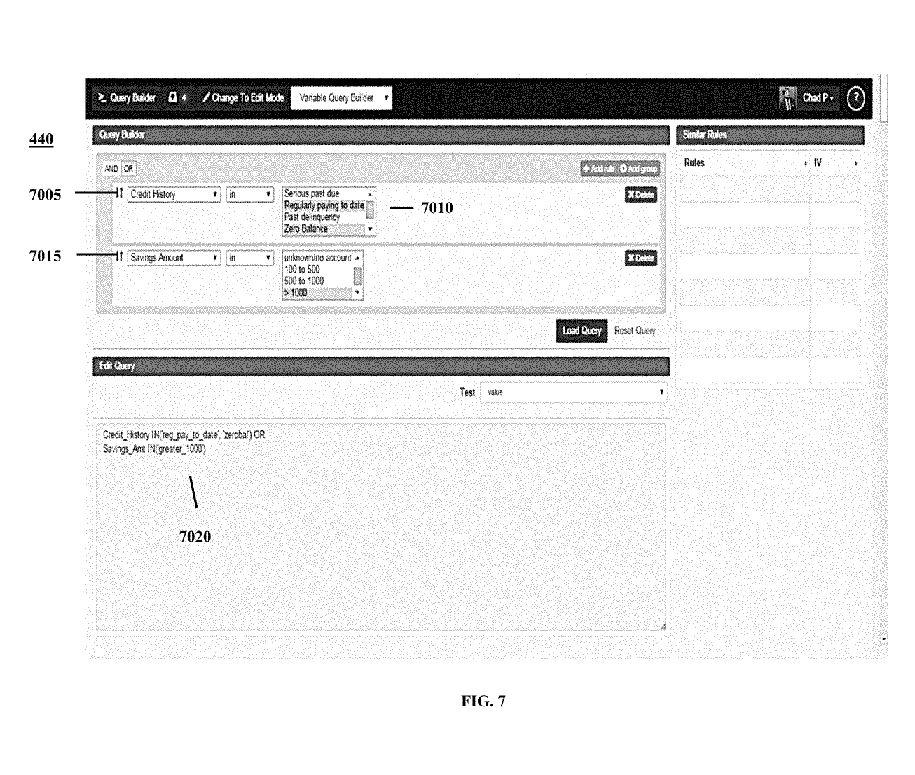

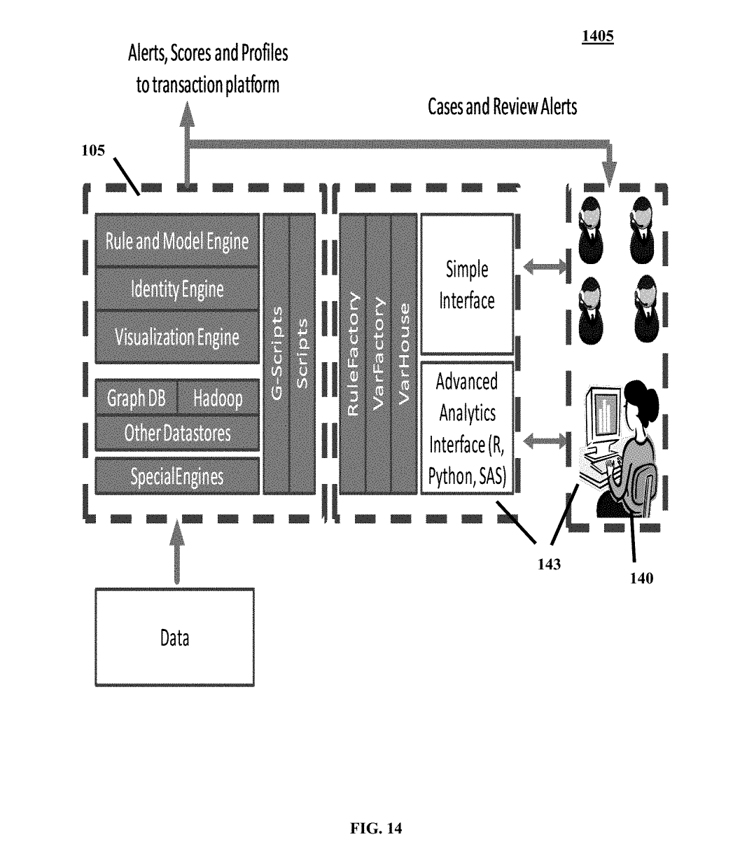

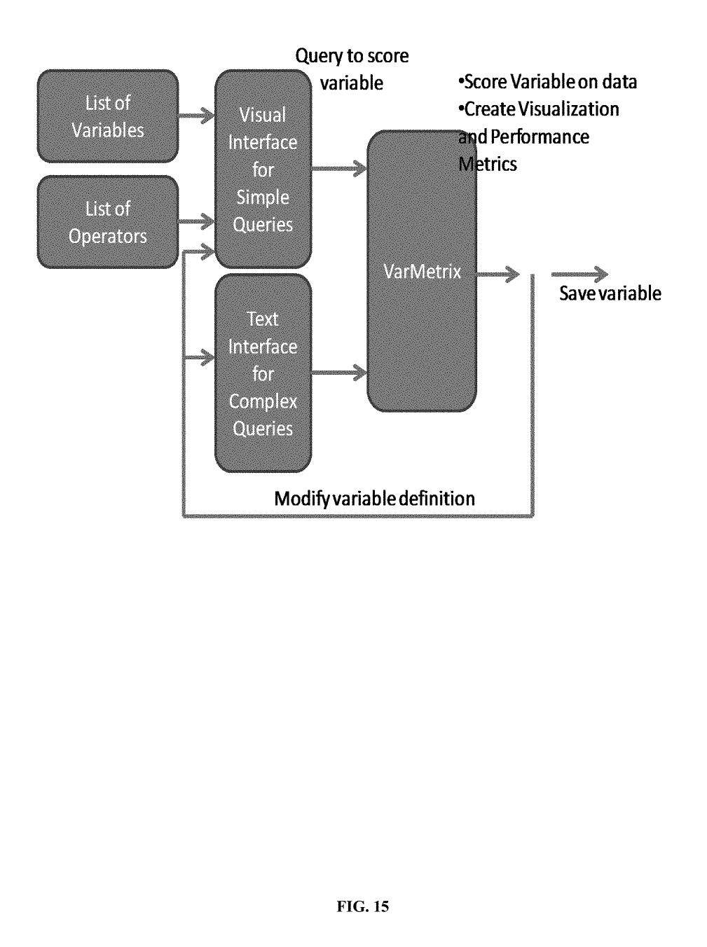

To aid understanding, this document is organized as follows. First, an exemplary collaborative anomaly detection system configured to identify an attack early using a limited number of data samples is briefly introduced with reference to FIG. 1. Second, with reference to FIGS. 2-4, the discussion turns to exemplary embodiments that illustrate anomaly detection system design. Specifically, illustrative anomaly detection network, pattern recognition system, and anomalous transaction modeling and visualization system designs are disclosed. Third, with reference to FIGS. 5-6, exemplary process flows illustrative of collaborative pattern recognition and anomalous transaction modeling and visualization are described. Fourth, with reference to FIGS. 7-13, various exemplary anomalous transaction modeling and visualization system user interface operational scenarios are disclosed. Then, with reference to FIG. 14, the design and operation of an exemplary collaborative anomaly detection system is presented. Finally, with reference to FIG. 15, an exemplary visualization and modeling system variable selection scenario is described to explain improvements in expert analyst variable selection and scoring.

FIG. 1 depicts an exemplary pattern recognition system configured to classify a transaction as anomalous or not anomalous as a function of a predictive analytic model configured to detect anomalies, generate a rule based on expert analysis of a limited number of data samples to classify as anomalous a transaction erroneously classified as not anomalous, augment the predictive analytic model with the generated rule, and deploy the augmented predictive analytic model to automatically identify an attack early in a live transaction stream. In FIG. 1, the exemplary pattern recognition system 105 includes the exemplary predictive analytic model 110 configured to detect fraudulent transactions in the transaction stream 115. In the depicted example, the transaction stream 115 includes transactions between the point of sale 120 and the airline ticket office 125. In the illustrated example, the pattern recognition system 105 classifies transactions in the transaction stream 115 as fraudulent or not fraudulent, as a function of the predictive analytic model 110 configured to detect fraud. In the depicted example, the transactions in the transaction stream 115 have been classified not fraudulent 130 by the pattern recognition system 105 as a function of the predictive analytic model 110. In the depicted embodiment, the airline ticket office 125 has reported transaction 135 as suspicious. In the illustrated example, the expert analyst 140 employs the exemplary fraudulent transaction visualization and modeling system 143 to evaluate the predictive analytic model 110 adequacy to detect fraud in the transaction stream 115. Throughout this disclosure, the expert analyst 140 may be referred to as an agent. In some examples, an agent may be a frontline agent. In an illustrative example, a frontline agent may be an expert analyst skilled at detection of anomalous data and tasked with analysis of live or recently live transaction data. For example, a frontline agent may be deployed to analyze transactions monitored by a bank card fraud center, to resolve suspicious cases, and judge whether a case should be classified as fraudulent. In the depicted example, the expert analyst accesses the predictive analytic model 115 and the transaction stream 115 via the network cloud 145. In the illustrated example, the expert analyst 140 confirms the transaction 135 from the transaction stream 115 is suspicious. In the depicted example, the expert analyst 140 is a human expert, visually manipulating, exploring, and analyzing the transaction stream 115 and the predictive analytic model 110 via a graphical user interface configured in the fraudulent transaction visualization and modeling system 143. In the illustrated example, the expert analyst 140 identifies distinguishing transaction criteria 150 using the new variables created by the expert analyst 140 as additional inputs and generating rules by fitting a decision tree that distinguish the suspicious transaction 135 from the other transaction stream 115 transactions. In the depicted embodiment, the distinguishing transaction criteria 150 include the location of the airline ticket office 125, the radius beyond a major city from the point of sale 120, and the inception date of the payment service used in the suspicious transaction 135. In various embodiments, the distinguishing transaction criteria 150 may include, for example, criteria such as a specific new card service, an area of operation, transaction size, or structure of the email address string and origin of buying instrument of a user. In the illustrated example, the expert analyst 140 notes in the fraudulent transaction visualization and modeling system 143 that the airline ticket office 125 is in a distant country, the point of sale 120 is over five hundred kilometers from a major city, and the payment service used in the suspicious transaction is an airline credit card service that entered operation within the last two weeks. In the depicted example, the expert analyst 140 generates a rule in the fraudulent transaction visualization and modeling system 143 based on the distinguishing transaction criteria 150, to correctly classify as fraudulent the transaction 135 erroneously classified as not fraudulent 130. In the illustrated example, the fraudulent transaction visualization and modeling system 143 augments the predictive analytic model 110 with the generated rule, creating the augmented predictive analytic model 155 based on the generated rule. In the depicted example, the pattern recognition system 105 deploys the augmented predictive analytic model 155 to automatically classify as fraudulent transactions matching the generated rule in the live transaction stream 160. In the illustrated example, the live transaction stream 160 includes transactions between the point of sale 120 and the airline ticket office 125. In the illustrated example, the pattern recognition system 105 classifies transactions in the transaction stream 160 as fraudulent or not fraudulent, as a function of the predictive analytic model 155 configured to detect fraud. In the depicted example, various transactions in the transaction stream 160 are classified as not fraudulent 165 by the pattern recognition system 105 as a function of the augmented predictive analytic model 155. In the illustrated example, the suspicious transaction 135 is correctly classified as fraudulent 170 by the pattern recognition system 105 as a function of the augmented predictive analytic model 155.

FIG. 2 depicts a schematic view of an exemplary collaborative anomaly detection network configured to classify a transaction as anomalous or not anomalous as a function of a predictive analytic model configured to detect anomalies, generate a rule based on expert analysis of a limited number of data samples to classify as anomalous a transaction erroneously classified as not anomalous, augment the predictive analytic model with the generated rule, and deploy the augmented predictive analytic model to automatically identify an attack early in a live transaction stream. In FIG. 2, according to an exemplary embodiment of the present disclosure, data may be transferred to the system, stored by the system and/or transferred by the system to users of the system across local area networks (LANs) or wide area networks (WANs). In accordance with various embodiments, the system may be comprised of numerous servers, data mining hardware, computing devices, or any combination thereof, communicatively connected across one or more LANs and/or WANs. One of ordinary skill in the art would appreciate that there are numerous manners in which the system could be configured, and embodiments of the present disclosure are contemplated for use with any configuration. Referring to FIG. 2, a schematic overview of a system in accordance with an embodiment of the present disclosure is shown. In the depicted embodiment, an exemplary system includes the exemplary pattern recognition system 105 configured to collaborate with the expert analyst 140 using the fraudulent transaction visualization and modeling system 143 to detect fraud in transactions between the point of sale 120 and the airline ticket office 125. In the illustrated embodiment, the point of sale 120 is a computing device configured to facilitate financial purchase transactions. In the depicted embodiment, the airline ticket office 125 is a computing device configured to facilitate the sale of goods and services. In the depicted example, the pattern recognition system 105 is a smart phone. In the illustrated embodiment, the fraudulent transaction visualization and modeling system 143 is a computing device configured with a neural network adapted to identify suspicious transactions as a function of historical transactions and truth data. In the illustrated embodiment, the pattern recognition system 105 is communicatively and operably coupled by the wireless access point 201 and the wireless link 202 with the network cloud 145 (e.g., the Internet) to send, retrieve, or manipulate information in storage devices, servers, and network components, and exchange information with various other systems and devices via the network cloud 145. In the depicted example, the illustrative system includes the router 203 configured to communicatively and operably couple the point of sale 120 to the network cloud 145 via the communication link 204. In the illustrated example, the router 203 also communicatively and operably couples the airline ticket office 125 to the network cloud 145 via the communication link 205. In the depicted embodiment, the fraudulent transaction visualization and modeling system 143 is communicatively and operably coupled with the network cloud 145 by the wireless access point 206 and the wireless communication link 207. In various examples, one or more of the pattern recognition system 105, point of sale 120, airline ticket office 125, or fraudulent transaction visualization and modeling system 143 may include an application server configured to store or provide access to information used by the system. In various embodiments, one or more application server may retrieve or manipulate information in storage devices and exchange information through the network cloud 145. In some examples, one or more of the pattern recognition system 105, point of sale 120, airline ticket office 125, or fraudulent transaction visualization and modeling system 143 may include various applications implemented as processor-executable program instructions. In some embodiments, various processor-executable program instruction applications may also be used to manipulate information stored remotely and process and analyze data stored remotely across the network cloud 145 (e.g., the Internet). According to an exemplary embodiment, as shown in FIG. 2, exchange of information through the network cloud 145 or other network may occur through one or more high speed connections. In some cases, high speed connections may be over-the-air (OTA), passed through networked systems, directly connected to one or more network cloud 145 or directed through one or more router. In various implementations, one or more router may be optional, and other embodiments in accordance with the present disclosure may or may not utilize one or more router. One of ordinary skill in the art would appreciate that there are numerous ways any or all of the depicted devices may connect with the network cloud 145 for the exchange of information, and embodiments of the present disclosure are contemplated for use with any method for connecting to networks for the purpose of exchanging information. Further, while this application may refer to high speed connections, embodiments of the present disclosure may be utilized with connections of any speed. In an illustrative example, components or modules of the system may connect to one or more of the pattern recognition system 105, point of sale 120, airline ticket office 125, or fraudulent transaction visualization and modeling system 143 via the network cloud 145 or other network in numerous ways. For instance, a component or module may connect to the system i) through a computing device directly connected to the network cloud 145, ii) through a computing device connected to the network cloud 145 through a routing device, or iii) through a computing device connected to a wireless access point. One of ordinary skill in the art will appreciate that there are numerous ways that a component or module may connect to a device via network cloud 145 or other network, and embodiments of the present disclosure are contemplated for use with any network connection method. In various examples, one or more of the pattern recognition system 105, point of sale 120, airline ticket office 125, or fraudulent transaction visualization and modeling system 143 could be comprised of a personal computing device, such as a smartphone, tablet computer, wearable computing device, cloud-based computing device, virtual computing device, or desktop computing device, configured to operate as a host for other computing devices to connect to. In some examples, one or more communications means of the system may be any circuitry or other means for communicating data over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

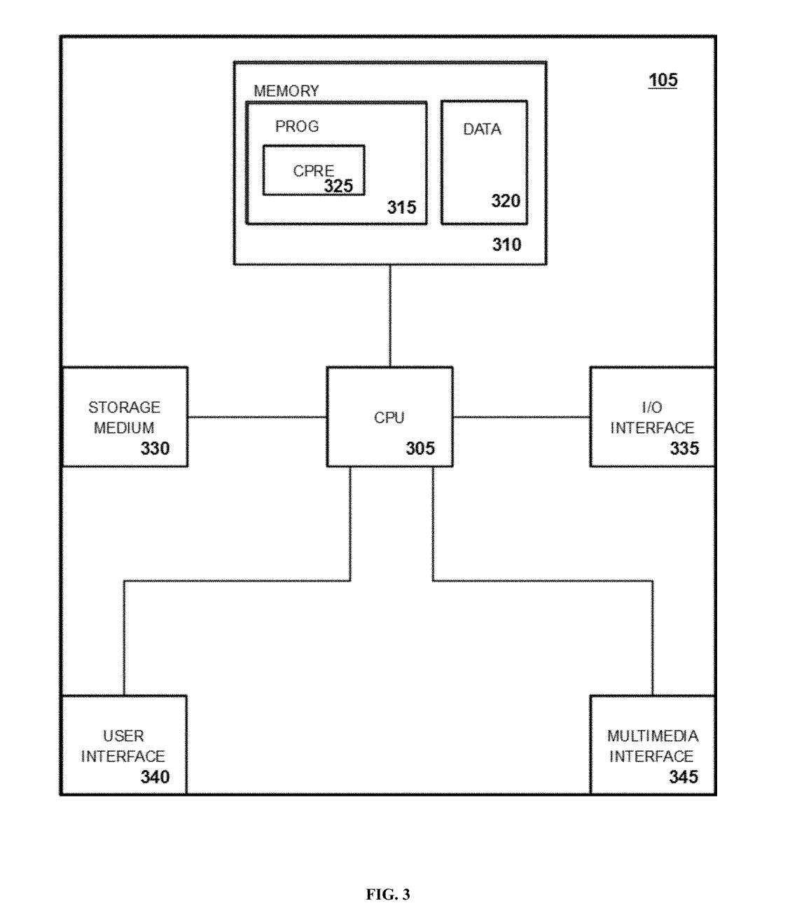

FIG. 3 depicts a structural view of an exemplary pattern recognition system configured to classify a transaction as anomalous or not anomalous. In FIG. 3, the block diagram of the exemplary pattern recognition system 105 includes processor 305 and memory 310. The processor 305 is in electrical communication with the memory 310. The depicted memory 310 includes program memory 315 and data memory 320. The depicted program memory 315 includes processor-executable program instructions implementing the CPRE (Collaborative Pattern Recognition Engine) 325. In various implementations, the depicted data memory 320 may include data configured to encode a predictive analytic model. In some embodiments, the illustrated program memory 315 may include processor-executable program instructions configured to implement an OS (Operating System). In various embodiments, the OS may include processor executable program instructions configured to implement various operations when executed by the processor 305. In some embodiments, the OS may be omitted. In some embodiments, the illustrated program memory 315 may include processor-executable program instructions configured to implement various Application Software. In various embodiments, the Application Software may include processor executable program instructions configured to implement various operations when executed by the processor 305. In some embodiments, the Application Software may be omitted. In the depicted embodiment, the processor 305 is communicatively and operably coupled with the storage medium 330. In the depicted embodiment, the processor 305 is communicatively and operably coupled with the I/O (Input/Output) interface 335. In the depicted embodiment, the I/O interface 335 includes a network interface. In various implementations, the network interface may be a wireless network interface. In some designs, the network interface may be a Wi-Fi interface. In some embodiments, the network interface may be a Bluetooth interface. In an illustrative example, the pattern recognition system 105 may include more than one network interface. In some designs, the network interface may be a wireline interface. In some designs, the network interface may be omitted. In the depicted embodiment, the processor 305 is communicatively and operably coupled with the user interface 340. In various implementations, the user interface 340 may be adapted to receive input from a user or send output to a user. In some embodiments, the user interface 340 may be adapted to an input-only or output-only user interface mode. In various implementations, the user interface 340 may include an imaging display. In some embodiments, the user interface 340 may include an audio interface. In some designs, the audio interface may include an audio input. In various designs, the audio interface may include an audio output. In some implementations, the user interface 340 may be touch-sensitive. In some designs, the pattern recognition system 105 may include an accelerometer operably coupled with the processor 305. In various embodiments, the pattern recognition system 105 may include a GPS module operably coupled with the processor 305. In an illustrative example, the pattern recognition system 105 may include a magnetometer operably coupled with the processor 305. In some embodiments, some or all parts of an exemplary pattern recognition system 105 system may be included within a client device, such that the functionalities could operate in a distributed manner. In some embodiments, the user interface 340 may include an input sensor array. In various implementations, the input sensor array may include one or more imaging sensor. In various designs, the input sensor array may include one or more audio transducer. In some implementations, the input sensor array may include a radio-frequency detector. In an illustrative example, the input sensor array may include an ultrasonic audio transducer. In some embodiments, the input sensor array may include image sensing subsystems or modules configurable by the processor 305 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In various implementations, the depicted memory 310 may contain processor executable program instruction modules configurable by the processor 305 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In some embodiments, the input sensor array may include audio sensing subsystems or modules configurable by the processor 305 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In various implementations, the depicted memory 310 may contain processor executable program instruction modules configurable by the processor 305 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In the depicted embodiment, the processor 305 is communicatively and operably coupled with the multimedia interface 345. In the illustrated embodiment, the multimedia interface 345 includes interfaces adapted to input and output of audio, video, and image data. In some embodiments, the multimedia interface 345 may include one or more still image camera or video camera. In various designs, the multimedia interface 345 may include one or more microphone. In some implementations, the multimedia interface 345 may include a wireless communication means configured to operably and communicatively couple the multimedia interface 345 with a multimedia data source or sink external to the pattern recognition system 105. In various designs, the multimedia interface 345 may include interfaces adapted to send, receive, or process encoded audio or video. In various embodiments, the multimedia interface 345 may include one or more video, image, or audio encoder. In various designs, the multimedia interface 345 may include one or more video, image, or audio decoder. In various implementations, the multimedia interface 345 may include interfaces adapted to send, receive, or process one or more multimedia stream. In various implementations, the multimedia interface 345 may include a GPU. In some embodiments, the multimedia interface 345 may be omitted. Useful examples of the illustrated pattern recognition system 105 include, but are not limited to, personal computers, servers, tablet PCs, smartphones, or other computing devices. In some embodiments, multiple pattern recognition system 105 devices may be operably linked to form a computer network in a manner as to distribute and share one or more resources, such as clustered computing devices and server banks/farms. Various examples of such general-purpose multi-unit computer networks suitable for embodiments of the disclosure, their typical configuration and many standardized communication links are well known to one skilled in the art, as explained in more detail in the foregoing FIG. 2 description. In some embodiments, an exemplary pattern recognition system 105 design may be realized in a distributed implementation. In an illustrative example, some pattern recognition system 105 designs may be partitioned between a client device, such as, for example, a phone, and, a more powerful server system, such as depicted in FIG. 2. In various designs, a pattern recognition system 105 partition hosted on a PC or mobile device may choose to delegate some parts of computation, such as, for example, machine learning or deep learning, to a pattern recognition host server. In some embodiments, a client device pattern recognition partition may delegate computation-intensive tasks to a pattern recognition host server to take advantage of a more powerful processor, or to offload excess work. In an illustrative example, some mobile devices may be configured with a mobile chip including an engine adapted to implement specialized processing, such as, for example, neural networks, machine learning, artificial intelligence, image recognition, audio processing, or digital signal processing. In some embodiments, such an engine adapted to specialized processing may have sufficient processing power to implement some pattern recognition system 105 features. However, in some embodiments, an exemplary pattern recognition system 105 may be configured to operate on device with less processing power, such as, for example, various gaming consoles, which may not have sufficient processor power, or a suitable CPU architecture, to adequately support a particular pattern recognition system 105 design. Various embodiment pattern recognition system 105 designs configured to operate on a such a device with reduced processor power may work in conjunction with a more powerful pattern recognition system 105 server system.

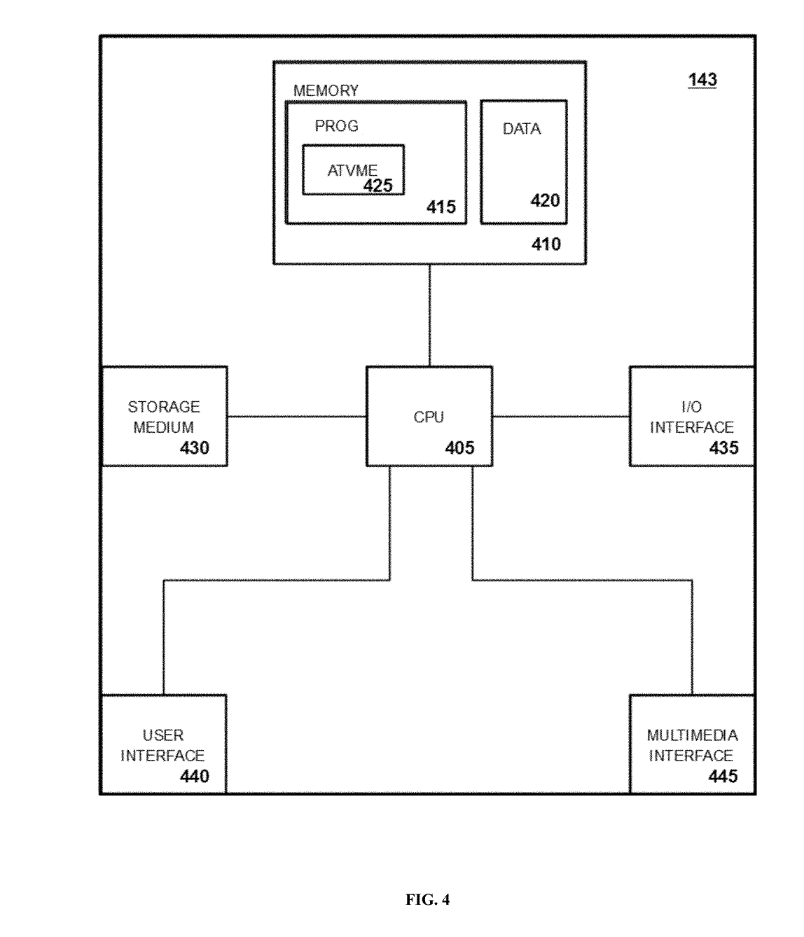

FIG. 4 depicts a structural view of an exemplary anomalous transaction visualization and modeling system configured to create visually perceptible transaction models and present the models for analysis and manipulation by a human analyst expert. In FIG. 4, the block diagram of the exemplary anomalous transaction visualization and modeling system 143 includes processor 405 and memory 410. The processor 405 is in electrical communication with the memory 410. The depicted memory 410 includes program memory 415 and data memory 420. The depicted program memory 415 includes processor-executable program instructions implementing the ATVME (Anomalous Transaction Visualization and Modeling Engine) 425. In various implementations, the depicted data memory 420 may include data configured to encode a predictive analytic model. In some embodiments, the illustrated program memory 415 may include processor-executable program instructions configured to implement an OS (Operating System). In various embodiments, the OS may include processor executable program instructions configured to implement various operations when executed by the processor 405. In some embodiments, the OS may be omitted. In some embodiments, the illustrated program memory 415 may include processor-executable program instructions configured to implement various Application Software. In various embodiments, the Application Software may include processor executable program instructions configured to implement various operations when executed by the processor 405. In some embodiments, the Application Software may be omitted. In the depicted embodiment, the processor 405 is communicatively and operably coupled with the storage medium 430. In the depicted embodiment, the processor 405 is communicatively and operably coupled with the I/O (Input/Output) interface 435. In the depicted embodiment, the I/O interface 435 includes a network interface. In various implementations, the network interface may be a wireless network interface. In some designs, the network interface may be a Wi-Fi interface. In some embodiments, the network interface may be a Bluetooth interface. In an illustrative example, the anomalous transaction visualization and modeling system 143 may include more than one network interface. In some designs, the network interface may be a wireline interface. In some designs, the network interface may be omitted. In the depicted embodiment, the processor 405 is communicatively and operably coupled with the user interface 440. In various implementations, the user interface 440 may be adapted to receive input from a user or send output to a user. In some embodiments, the user interface 440 may be adapted to an input-only or output-only user interface mode. In various implementations, the user interface 440 may include an imaging display. In some embodiments, the user interface 440 may include an audio interface. In some designs, the audio interface may include an audio input. In various designs, the audio interface may include an audio output. In some implementations, the user interface 440 may be touch-sensitive. In some designs, the anomalous transaction visualization and modeling system 143 may include an accelerometer operably coupled with the processor 405. In various embodiments, the anomalous transaction visualization and modeling system 143 may include a GPS module operably coupled with the processor 405. In an illustrative example, the anomalous transaction visualization and modeling system 143 may include a magnetometer operably coupled with the processor 405. In some embodiments, some or all parts of an exemplary anomalous transaction visualization and modeling system 143 system may be included within a client device, such that the functionalities could operate in a distributed manner. In some embodiments, the user interface 440 may include an input sensor array. In various implementations, the input sensor array may include one or more imaging sensor. In various designs, the input sensor array may include one or more audio transducer. In some implementations, the input sensor array may include a radio-frequency detector. In an illustrative example, the input sensor array may include an ultrasonic audio transducer. In some embodiments, the input sensor array may include image sensing subsystems or modules configurable by the processor 405 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In various implementations, the depicted memory 410 may contain processor executable program instruction modules configurable by the processor 405 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In some embodiments, the input sensor array may include audio sensing subsystems or modules configurable by the processor 405 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In various implementations, the depicted memory 410 may contain processor executable program instruction modules configurable by the processor 405 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In the depicted embodiment, the processor 405 is communicatively and operably coupled with the multimedia interface 445. In the illustrated embodiment, the multimedia interface 445 includes interfaces adapted to input and output of audio, video, and image data. In some embodiments, the multimedia interface 445 may include one or more still image camera or video camera. In various designs, the multimedia interface 445 may include one or more microphone. In some implementations, the multimedia interface 445 may include a wireless communication means configured to operably and communicatively couple the multimedia interface 445 with a multimedia data source or sink external to the anomalous transaction visualization and modeling system 143. In various designs, the multimedia interface 445 may include interfaces adapted to send, receive, or process encoded audio or video. In various embodiments, the multimedia interface 445 may include one or more video, image, or audio encoder. In various designs, the multimedia interface 445 may include one or more video, image, or audio decoder. In various implementations, the multimedia interface 445 may include interfaces adapted to send, receive, or process one or more multimedia stream. In various implementations, the multimedia interface 445 may include a GPU. In some embodiments, the multimedia interface 445 may be omitted. Useful examples of the illustrated anomalous transaction visualization and modeling system 143 include, but are not limited to, personal computers, servers, tablet PCs, smartphones, or other computing devices. In some embodiments, multiple anomalous transaction visualization and modeling system 143 devices may be operably linked to form a computer network in a manner as to distribute and share one or more resources, such as clustered computing devices and server banks/farms. Various examples of such general-purpose multi-unit computer networks suitable for embodiments of the disclosure, their typical configuration and many standardized communication links are well known to one skilled in the art, as explained in more detail in the foregoing FIG. 2 description. In some embodiments, an exemplary anomalous transaction visualization and modeling system 143 design may be realized in a distributed implementation. In an illustrative example, some anomalous transaction visualization and modeling system 143 designs may be partitioned between a client device, such as, for example, a phone, and, a more powerful server system, such as depicted in FIG. 2. In various designs, an anomalous transaction visualization and modeling system 143 partition hosted on a PC or mobile device may choose to delegate some parts of computation, such as, for example, machine learning or deep learning, to a pattern recognition host server. In some embodiments, a client device pattern recognition partition may delegate computation-intensive tasks to a pattern recognition host server to take advantage of a more powerful processor, or to offload excess work. In an illustrative example, some mobile devices may be configured with a mobile chip including an engine adapted to implement specialized processing, such as, for example, neural networks, machine learning, artificial intelligence, image recognition, audio processing, or digital signal processing. In some embodiments, such an engine adapted to specialized processing may have sufficient processing power to implement some anomalous transaction visualization and modeling system 143 features. However, in some embodiments, an exemplary anomalous transaction visualization and modeling system 143 may be configured to operate on device with less processing power, such as, for example, various gaming consoles, which may not have sufficient processor power, or a suitable CPU architecture, to adequately support a particular anomalous transaction visualization and modeling system 143 design. Various embodiment anomalous transaction visualization and modeling system 143 designs configured to operate on a such a device with reduced processor power may work in conjunction with a more powerful anomalous transaction visualization and modeling system 143 server system.

FIG. 5 depicts a process flow of an exemplary CPRE (Collaborative Pattern Recognition Engine) configured to identify an attack early using a limited number of data samples. The method depicted in FIG. 5 is given from the perspective of the CPRE (Collaborative Pattern Recognition Engine) 325 executing as program instructions on the processor (CPU) 305, depicted in FIG. 3. In the illustrated embodiment, the CPRE 325 executes as program instructions on the processor 305 configured in the CPRE host collaborative pattern recognition computing device 105, depicted in at least FIG. 1, FIG. 2, and FIG. 3. In some embodiments, the CPRE 325 may execute as a cloud service communicatively coupled with system services, hardware resources, or software elements local to and/or external to the CPRE host collaborative pattern recognition computing device 105. The depicted method 500 begins at step 505 with the processor 305 receiving an electronic message comprising a predictive analytic model configured to detect anomalies. The method continues at step 510 with the processor 305 receiving from a live transaction stream a transaction to be classified as anomalous or not anomalous. The method continues at step 515 with the processor 305 computing a classification score determined as a function of the transaction and the predictive analytic model. The method continues at step 520 with the processor comparing the classification score to a predetermined minimum classification score, to determine if the transaction is anomalous, based on determining if the classification score is greater than or equal to the predetermined minimum. The method continues at step 525 with the processor 305 performing a test to determine if the transaction is anomalous, based on the comparison performed by the processor 305 at step 520. Upon a determination by the processor 305 at step 525 the transaction is anomalous, the method continues at step 530 with the processor 305 sending to a predetermined recipient an electronic message comprising an Anomaly Detected Alert. In various embodiments, the processor 305 may send the Anomaly Detected Alert to an agent. Upon a determination by the processor 305 at step 525 the transaction is not anomalous, the method continues at step 535 with the processor 305 comparing the classification score to a predetermined maximum classification score, to determine if the transaction is not anomalous, based on determining if the classification score is less than the predetermined maximum. The method continues at step 540 with the processor 305 performing a test to determine if the transaction is not anomalous, based on the comparison performed by the processor 305 at step 535. Upon a determination by the processor 305 at step 540 the transaction is not not anomalous, the method continues at step 540 with the processor 305 flagging the transaction as suspicious. Upon a determination by the processor 305 at step 540 the transaction is not anomalous, the method continues at step 550 with the processor 305 performing a test to determine if a new predictive analytic model is available. Upon a determination by the processor 305 at step 550 a new predictive model is available, the method continues at step 505 with the processor 305 receiving an electronic message comprising a predictive analytic model configured to detect anomalies. Upon a determination by the processor 305 at step 550 a new predictive model is not available, the method continues at step 510 with the processor 305 receiving from a live transaction stream a transaction to be classified as anomalous or not anomalous.

Various embodiment CPRE 325 designs may include processor-executable program instructions implementing a continuously updated adaptive decision engine powered by frontline agents. In various examples, an embodiment CPRE 325 design may be referred to as a FrontLogic implementation. An embodiment FrontLogic design may provide a new process to have continuously adapting models to identify specific patterns and anomalies. In various examples, an embodiment FrontLogic design's models may be continuously adapted through an exemplary Variable Search, Use and Management Interface implemented in an illustrative ATVME (Anomalous Transaction Modeling and Visualization Engine) 425, depicted, for example, at least in FIG. 4. In various examples illustrative of FrontLogic embodiment implementations, the innovation is in the use of frontline agents for the task of continuously adapting models to identify specific patterns and anomalies. Various exemplary FrontLogic embodiment designs may provide a new process to have a continuously updated model that continues to improve performance. In an illustrative example, some FrontLogic embodiment designs enable a new workflow that will allow frontline agents to quantify their insights and case knowledge into predictive variables by using a variety of simplifying interfaces and analytics. For example, in some exemplary scenarios illustrative of various FrontLogic embodiments' usage, frontline agents may quantify their insights and case knowledge into predictive variables by using one or more exemplary Variable Search, Use and Management Interface, such as, for example, may be provided through exemplary VarFactory and RuleFactory designs, disclosed with reference to FIG. 6. In an illustrative example, the predictive variables identified by frontline agents using an exemplary Variable Search, Use and Management Interface are dynamically updated features, reflecting past and current trends. In various scenarios illustrative of some FrontLogic embodiments' usage, the variables identified by frontline agents using an exemplary Variable Search, Use and Management Interface may then be incorporated into rules and models which will help make process decisions in current and evolving contexts. In some examples, an embodiment FrontLogic implementation may make process decisions in current and evolving contexts, such as, for example, a live transaction stream. In various examples, an embodiment FrontLogic implementation may make process decisions as a function of a rule or model created by a frontline agent in an exemplary Variable Search, Use and Management Interface. In an illustrative example, various embodiment FrontLogic implementations may be designed to enable a user to create variables without necessarily including each of the different capabilities described.

In some embodiments, an exemplary FrontLogic implementation may include a scripting interface accessible to frontline agents for prediction, pattern detection, and anomaly detection. In some examples, and embodiment FrontLogic scripting interface may include a library of powerful algorithms, such as, for example, new heuristics and algorithms may better identify anomalies and predict outcomes with high rates of predictivity and special properties such as structural stability (re-optimization of variables in CART and RandomForest, maximizing performance improvement with minimal structural change).

In various embodiment implementations, an exemplary FrontLogic scripting interface design may include a set of pre-defined lists of variables, rules and models for accurately identifying patterns, anomalies and outcomes. In an illustrative example, the pre-defined lists of variables, rules and models provided by an illustrative FrontLogic scripting interface may include standard models like logistic, neural network, decision tree, random forest, combination of trees and logistic/other model, principal components, Hidden Markov models, structurally stable trees etc., that are customized for superior performance. In various examples, an exemplary FrontLogic scripting interface may include the use of a wide variety of data sources including but not limited to transaction, profile, identity, social, device, credit and third party data, organized for maximum predictivity in a set of pre-defined use cases. In an illustrative example, various embodiment FrontLogic scripting interface implementations may be designed to enable a user to perform prediction, pattern detection, and anomaly detection without necessarily including each of the different capabilities described.

In some embodiment implementations, an exemplary FrontLogic scripting interface design may include a library of graph variables and graph-based models to identify specific types of patterns or anomalies, with high degree of certainty. In various illustrative examples, an embodiment set of FrontLogic scripting interface algorithms useful for analysis and manipulation of graph data may be referred to as a G-Scripts implementation. In some embodiments, an exemplary G-Scripts implementation may include a set of useful algorithms for use in graph data, such as, for example, definitions of key metrics/variables defined on graps/sub-graphs, common routines to identify shortest distances to specific nodes, construction of minimum spanning trees to identify rings, specific configurations of models like decision tress and logistic models, learning algorithms on graphs, efficiently covering the graph to identify anomalies, efficient computation and storage of metrics, and the like, using transaction, profile, identity, device, social, credit and third party data. In an illustrative example, various embodiment FrontLogic G-Scripts library implementations may be designed to enable analysis and manipulation of graph data without necessarily including each of the different capabilities described.

FIG. 6 depicts a process flow of an exemplary ATMVE (Anomalous Transaction Modeling and Visualization Engine) configured to create visually perceptible transaction models and present the models for analysis and manipulation by a human analyst expert. The method depicted in FIG. 6 is given from the perspective of the ATMVE (Anomalous Transaction Modeling and Visualization Engine) 425 executing as program instructions on the processor (CPU) 405, depicted in FIG. 4. In the illustrated embodiment, the ATMVE 425 executes as program instructions on the processor 405 configured in the ATMVE host anomalous transaction modeling and visualization computing device 143, depicted in at least FIG. 1, FIG. 2, and FIG. 4. In some embodiments, the ATMVE 425 may execute as a cloud service communicatively coupled with system services, hardware resources, or software elements local to and/or external to the ATMVE host anomalous transaction modeling and visualization computing device 143. The depicted method 600 begins at step 605 with the processor 405 receiving an electronic message comprising a predictive analytic model and a transaction to model and visualize. The method continues at step 610 with the processor 405 modelling the transaction attributes to create a visually perceptible transaction model and present the model to an agent in a graphical user interface. The method continues at step 615 with the processor 405 receiving an electronic message comprising a new candidate variable selected by the agent in the user interface. The method continues at step 620 with the processor 405 receiving an electronic message comprising a selected variable value chosen by the agent in the user interface. The method continues at step 625 with the processor 405 generating a new rule as a function of the new variable and value. The method continues at step 630 with the processor 405 creating an updated predictive analytic model based on augmenting the existing predictive analytic model as a function of the generated rule. The method continues at step 635 with the processor sending an electronic message comprising the updated predictive analytic model to a predetermined recipient. In various embodiments, the processor 405 may send the electronic message comprising the updated predictive analytic model to a collaborative pattern recognition system. At step 640, the method ends.

Various embodiment ATMVE 425 designs may include processor executable program instructions implementing a Variable Search, Use and Management Interface. In an illustrative example, some embodiment ATMVE 425 Variable Search, Use and Management Interface implementations may be referred to as VarHouse. In various examples, an embodiment VarHouse implementation may provide an intuitive interface to tag and search for variables, review variable performance, and usage. An embodiment VarHouse design may include a software program that allows users to catalog, use, and maintain a large number of variables locally or in the cloud. In an illustrative example, some embodiment VarHouse implementations may include capabilities to provide qualitative/quantitative descriptions of variables, categorization, tag/search for variables, group variables based on type of context/metric/usage, evaluate predictive power of variables, review usage, provide reporting, or any other capability that is required to operate a large set of variables to make them accessible, understandable/usable, reduce duplication (tractable), and maximize performance (reporting). In an example illustrative of some embodiments' usage, various embodiment VarHouse implementations may be used to manage variables without necessarily including each of the different capabilities (search, predictivity, categorization, optimization).

In an illustrative example, some embodiment VarHouse implementations may include a Variable Creation Interface. In some examples, an embodiment VarHouse Variable Creation Interface may be referred to as a VarFactory implementation.

Various embodiment VarFactory Variable Creation Interface implementation examples may include interfaces configured to enable an analyst expert to evaluate variable performance, create variables, and identify trends and patterns. In an illustrative example, some embodiment VarFactory designs may include one or more interface such as:
VarGen—a simple new interface to enable Analysts to create non-graph variables. Some embodiments may include a proprietary interface to help specify the variable.
G-VarGen—a simple new interface to enable Analysts to create graph-type variables. Some embodiments may include a proprietary interface to help specify the variable.
VarMetrix—a simple new interface to evaluate variable performance
PatternGopher: a simple smart tool to help automated identification of a variety of numerical, text, sound and other patterns that humans typically apply to identify trends. Some embodiments may include a support interface with graphical tools to aid the identification of trends and insights.

Various exemplary VarFactory embodiment designs may include processor-executable program instructions configured to enable a wide spectrum of users (skilled programmers to non-programmers) to synthesize new variables, for use in rules and models.

In various embodiment implementation examples, some VarFactory designs may use a graphical interface (VarGen) with drag and drop items to enable arithmetic/logical/Boolean and other operations on inputs, to construct variables. In an illustrative example, some embodiment VarFactory implementations may then generate logic to score the variable in a machine readable form (e.g., SQL, java, C). Some embodiments may also allow advanced users to perform the same operation directly using higher level languages/programs like R, Python and SAS.

Various embodiment VarFactory implementations may also have a capability to allow users to construct graph variables (i.e., operations on graph-like data) using an intuitive graphical interface. In various examples, an exemplary interface may be referred to as G-VarGen. Some embodiment G-VarGen examples may allow a user to identify relationships, subgraphs and construct metrics on them such as the distance from a bad actor, variation from the group and size of the group. Some exemplary G-VarGen embodiment usage scenarios may include identifying accounts linked to known good/bad actors, transaction patterns, or account profiles. For example, some embodiment G-VarGen implementations may include functionality to support a variety of analytics and charting to help show insights, define bins for variable values and to evaluate the performance of variables as predictors of specific metrics, compare overlap with other variables and incremental lift. In an illustrative example, various G-VarGen embodiment implementations may permit a user to set up filters to restrict time range of data and to good/bad transactions, to help identify patterns among specific transactions.

Some embodiment VarFactory implementations may include one or more pattern identifying capability (for example, combining human and machine capabilities) configured to detect patterns automatically and provide recommendations to users. Various VarFactory embodiment pattern identifying capability implementations may be referred to as patternGopher. Some embodiment patternGopher designs may include the ability to construct numerical patterns, or patterns related by sequences or sounds, as features common to a specific target group.

In an illustrative example, various embodiment VarFactory and VarHouse implementations may be designed to enable a user to create variables and patterns without necessarily including each of the different capabilities described.

In an illustrative example, various embodiment VarHouse implementations may include a Rule Creation Interface. In various examples, an embodiment VarHouse Rule Creation Interface may be referred to as a RuleFactory implementation.

Some embodiment RuleFactory Rule Creation Interface implementation examples may include interfaces configured to create, explore, analyze, and evaluate rules, variables, and patterns. In an illustrative example, various embodiment RuleFactory implementations may include one or more interface such as:
RuleMill—a simple new interface to enable Analysts to create new rules. Some embodiments may include a proprietary interface to help specify the rule.
G-RuleMill—a simple new interface to enable Analysts to create new graph-type rules. Some embodiments may include a proprietary interface to help specify the rule.
RuleMetrix—a simple new interface to evaluate rule performance

Various exemplary RuleFactory embodiment designs may include processor-executable program instructions configured to enable rules to be classified as a special category of complex variable with discrete outcomes. In an illustrative example, some RuleFactory embodiment designs may include processor-executable program instructions configured to enable a wide spectrum of users (skilled programmers to non-programmers) to synthesize new rules. Some RuleFactory embodiment implementations may use a graphical interface (for example, an embodiment RuleMill design) including drag and drop items configured to enable arithmetic/logical/Boolean and other operations on inputs, to construct rules. Various embodiments may then generate logic to score the rule in a machine readable form (for example, SQL, java, C). In some embodiments, an exemplary RuleFactory design may also allow advanced users to perform the same operation directly using higher level languages/programs like R, Python and SAS.

Some embodiment RuleFactory implementations may include an interface configured to permit users to construct graph-type rules (i.e., operations on graph-like data) using an intuitive graphical interface. In various examples, an embodiment RuleFactory graph-type rule construction interface may be referred to as a G-RuleMill implementation. In some examples, a G-RuleMill embodiment implementation may allow the user to identify relationships, subgraphs and construct metrics on them, such as, for example, the distance from a bad actor, variation from the group, and size of the group. Various usage scenarios exemplary of some G-RuleMill embodiments may include identifying accounts linked to known good/bad actors, recognizing transaction patterns, or identifying account profiles linked to a recognized pattern.

Various embodiment RuleFactory implementations may include a capability to support a variety of analytics and charting. In some examples, an embodiment RuleFactory analytics and charting interface may be referred to as a RuleMetrix implementation. In various examples, a RuleMetrix embodiment implementation may show insights, evaluate the performance of rule-defined criteria (for example, subgroups) as predictors of specific metrics, compare overlap with other rules, incremental lift, or ruleset optimization. In an example illustrative of some RuleMetrix embodiments' usage, a user may set up filters to restrict time range of data and to good/bad transactions, to help identify patterns among specific transactions.

In an illustrative example, various embodiment RuleFactory and VarHouse implementations may be designed to enable a user to create rules, variables, and patterns without necessarily including each of the different capabilities described.

FIG. 7 depicts a screen capture view of an exemplary ATMVE (Anomalous Transaction Modeling and Visualization Engine) user interface operational scenario illustrating exemplary variable query construction. In FIG. 7, the exemplary anomalous transaction visualization and modeling system 143 user interface 440 presents an exemplary variable query construction interface illustrating the selection of various attributes and values to be used to generate a query. In the depicted example, the exemplary query construction interface includes the variable name selector 7005 and the variable value selector 7010. In the illustrated example, the variable values are either “Regularly paying to date” or “Zero Balance.” In the depicted embodiment, the exemplary query construction interface includes the criterion selector 7015. In the illustrated example, the criterion is the OR of the first row and second row. In the depicted example, the Edit Query window 7020 displays the query automatically built by the system in SQL. In the depicted embodiment, the query automatically built by the system may be edited directly by an agent in the Edit Query window 7020.

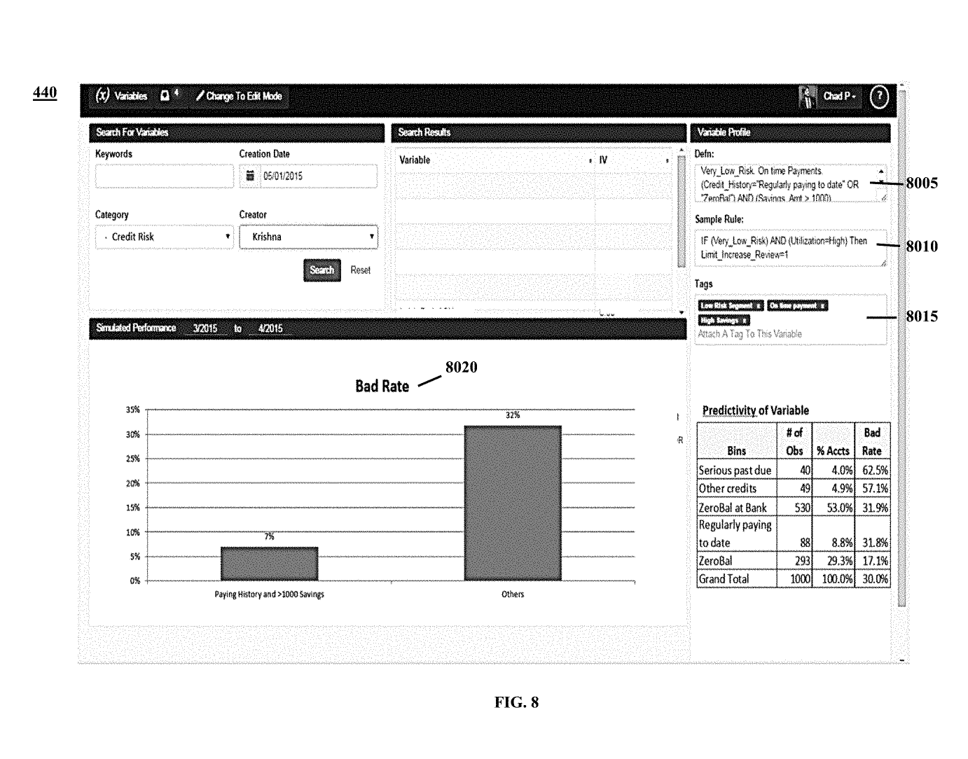

FIG. 8 depicts a screen capture view of an exemplary ATMVE (Anomalous Transaction Modeling and Visualization Engine) user interface operational scenario illustrating exemplary variable performance evaluation. In FIG. 8, the exemplary anomalous transaction visualization and modeling system 143 user interface 440 presents an overview of the variable performance including the number of rows in which it is missing, and how accurately it can split the dataset into segments that are most and least anomalous (for example, accounts with the value “Serious past due” and “Other credits” in this example have the highest rate of anomalies). In various examples, the agent may quickly look at the chart to decide if the variable is useful (that is, if the variable divides the data into segments with a high anomaly rate versus a segment without). In the depicted example, the query definition window 8005 displays the query that was used to construct the variable. In the illustrated example, the Sample Rule window 8010 displays a sample rule randomly chosen from the database that contains this variable. In the depicted example, the Tags window 8015 displays this variables' tags. In an illustrative example, each variable has “tags” which are like search tags, and these are created at the time the variable is created. For example, when another new variable is created, these tags are helpful in identifying any existing related variables in the system, which may be helpful in constructing the new variable and also avoiding duplication. In the illustrated example, the Bad Rate window 8020 displays the percentage of accounts in the segment that are anomalous.

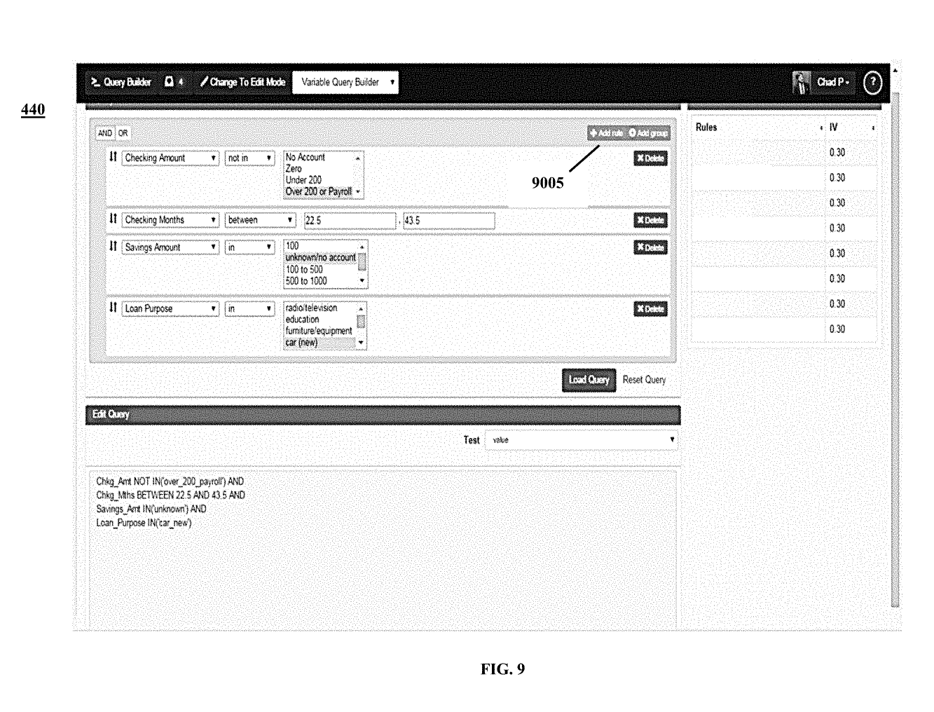

FIG. 9 depicts a screen capture view of an exemplary ATMVE (Anomalous Transaction Modeling and Visualization Engine) user interface operational scenario illustrating an alternative variable query construction example. In FIG. 9, the exemplary anomalous transaction visualization and modeling system 143 user interface 440 presents an example variable query construction interface illustrating the viewing and selection of various attribute values. In the depicted example, the add rule/add group button 9005 may be used to manipulate criteria row by row or as a group.

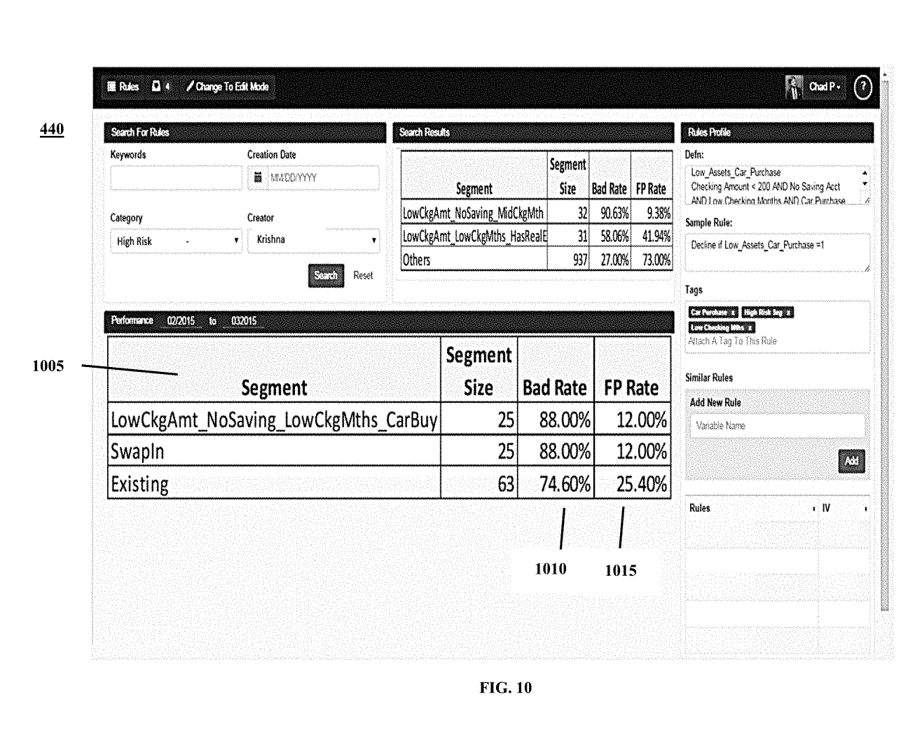

FIG. 10 depicts a screen capture view of an exemplary ATMVE (Anomalous Transaction Modeling and Visualization Engine) user interface operational scenario illustrating exemplary rule construction. In FIG. 10, the exemplary anomalous transaction visualization and modeling system 143 user interface 440 presents an exemplary sample segment 1005 which represents a terminal node of a tree. In the depicted example, there are 25 accounts satisfying the criteria defined by this segment, with an associated bad rate 1010 and false positive rate 1015.

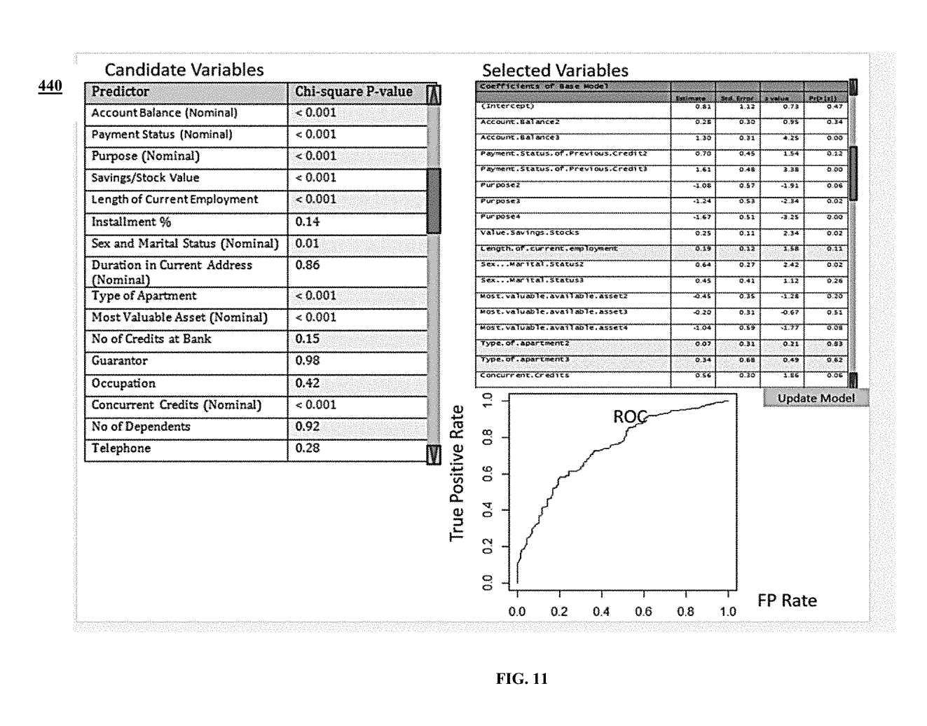

FIG. 11 depicts a screen capture view of an exemplary ATMVE (Anomalous Transaction Modeling and Visualization Engine) user interface operational scenario illustrating an exemplary model constructed as a function of candidate variables selected by an agent. In FIG. 11, the exemplary anomalous transaction visualization and modeling system 143 user interface 440 presents the agent with candidate variables for selection by the agent to build a sample model. In the depicted embodiment, the full list of variables is to the left. In an illustrative example, based on the performance of the variable, the agent may drag a variable subset to the right and build the model (the “update” button will initiate a process of fitting the model, and the best fit using the variables selected by the agent will be displayed by the user interface 440).

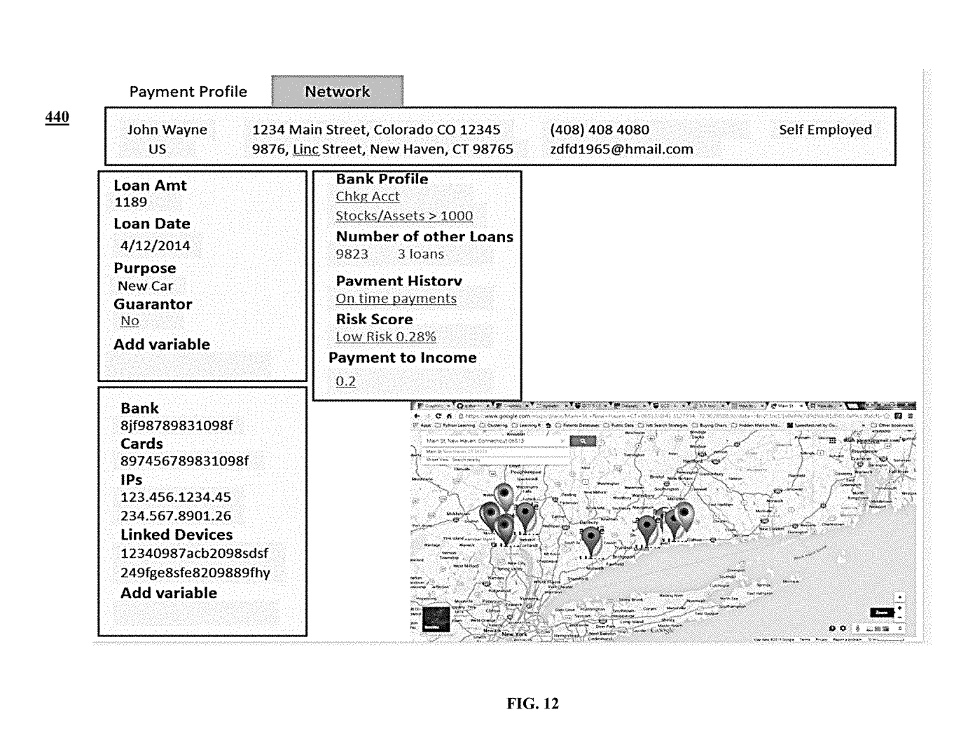

FIG. 12 depicts a screen capture view of an exemplary ATMVE (Anomalous Transaction Modeling and Visualization Engine) user interface operational scenario illustrating an exemplary payment account profile. In FIG. 12, the exemplary anomalous transaction visualization and modeling system 143 user interface 440 presents various attribute values included in a payment account. In various examples, the depicted payment account may be identified by an exemplary rule. In the depicted example, the illustrated account view was constructed using credit data from a publicly available sample dataset. All the data in the illustrated example is fictitious.

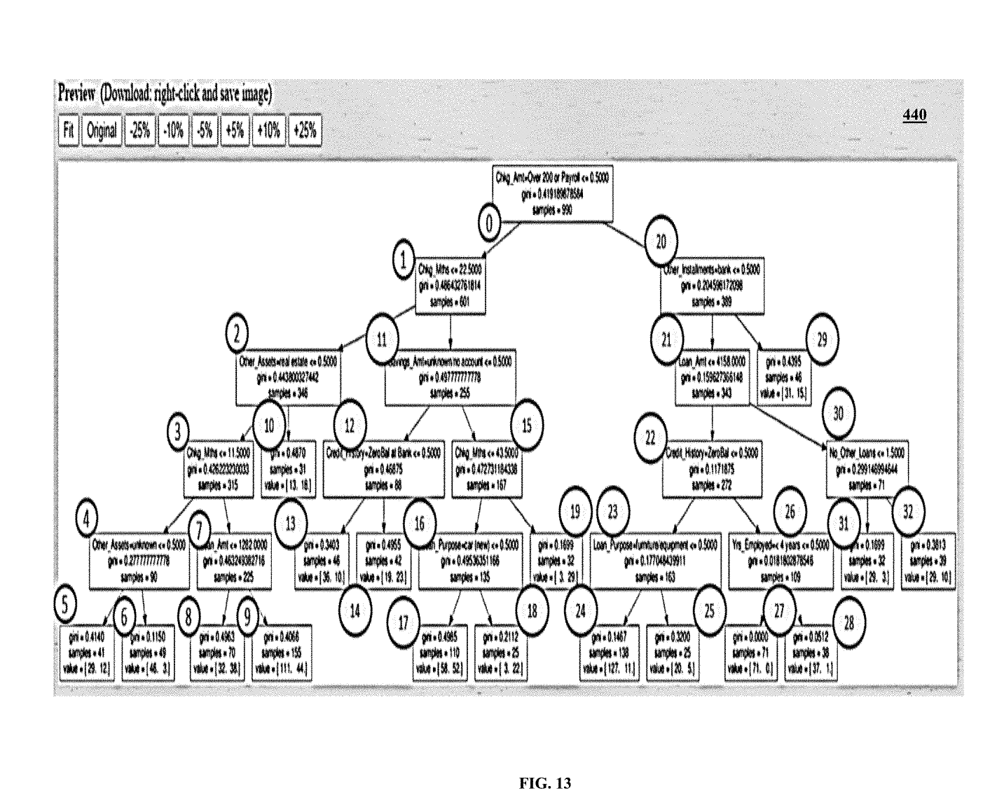

FIG. 13 depicts a screen capture view of an exemplary ATMVE (Anomalous Transaction Modeling and Visualization Engine) user interface operational scenario illustrating an exemplary decision tree constructed as a function of candidate variables selected by an agent. In FIG. 13, the exemplary anomalous transaction visualization and modeling system 143 user interface 440 presents a sample decision tree in which any of the nodes can be made into a rule/criterion that defines the segment corresponding to the node.

FIG. 14 depicts a structural view of an exemplary collaborative anomaly detection system design. In the example depicted by FIG. 14, the exemplary Continuously Adapted Anomaly Detection System (CAADE) 1405 includes the exemplary pattern recognition system 105, also depicted at least in FIGS. 1, 2, and 3, communicatively and operably coupled with the exemplary anomalous transaction visualization and modeling system 143, also depicted at least in FIGS. 1, 2, and 4. In the illustrated embodiment, the pattern recognition system 105 includes a predictive analytic model configured to classify as anomalous or not anomalous transactions in the depicted data stream monitored by the pattern recognition system 105. In the depicted embodiment, the expert analyst 140, also depicted at least in FIG. 1, uses the anomalous transaction visualization and modeling system 143 to visually explore, analyze, and manipulate transactions classified by the pattern recognition system 105 as anomalous or not anomalous. In the illustrated embodiment, the expert analyst 140 selects new variables and generates new rules to improve the predictive analytic model performance classifying transactions as anomalous or not anomalous. In the depicted embodiment, the expert analyst 140 uses the anomalous transaction visualization and modeling system 143 to configure a new predictive analytic model with improved classification performance, based on the new variables selected and new rules generated by the expert analyst 140 using the anomalous transaction visualization and modeling system 143. In the illustrated embodiment, the expert analyst 140 deploys the improved predictive analytic model to the pattern recognition system 105, to classify as anomalous or not anomalous transactions in the depicted data stream, with improved classification performance. In this illustrative example, the Continuously Adapted Anomaly Detection System 1405 achieves with a limited number of data samples rapid predictive analytic model performance improvement classifying transactions as anomalous or not anomalous, based on the new variables selected and new rules generated by the expert analyst 140 using the anomalous transaction visualization and modeling system 143. In some examples, an exemplary Continuously Adapted Anomaly Detection System 1405 may facilitate early fraud or other attack detection using a limited number of data samples, based on collaborative performance improvement of the predictive analytic model augmented by the expert analyst 140 using the anomalous transaction visualization and modeling system 143 to visually explore and manipulate transactions classified by the pattern recognition system 105.

In various exemplary scenarios, the expert analyst 140 may start by first integrating all of the relevant input data. The expert analyst 140 may then optionally initialize the system by looking at the pre-defined library of variables, rules and models (Scripts) and scoring them in the system using the data. In some illustrative scenarios, the relative incremental contribution of each of the variables may be evaluated, and only the predictive variables may be retained (VarMetrix). In a similar example, the ruleset may also be scored for incremental impact and only the impactful rules retained (RuleMetrix). In an illustrative example, the key models may then be initialized using the internal and external variables, and data. In some embodiments, the model performance may then be tested for performance, and improved until it meets benchmarks that may be set by the expert analyst 140 or derived automatically from operational parameters set by the expert analyst 140.

In some illustrative scenarios, a selected set of agents may periodically receive a group of cases that are created by the system (Scripts). In some embodiments, an exemplary PatternGopher implementation may also be applied to the cases, to identify defining features and provide them as suggestions to the agent. In an illustrative example, an agent may review the cases using an exemplary CaseReview tool, to get an understanding of the fraud pattern. In some scenarios, the agent may also look at some of the existing variables relevant to these patterns (in VarHouse, for example) to understand existing variables and performance. In some examples, the agent then may use embodiment VarGen and R-VarGen implementations to evaluate (using VarMetrix) and build impactful new variables. In various scenarios, the agent may use these variables in RuleMill and G-RuleMill to create new rules and measure their performance using RuleMetrix. In an illustrative example, in the model update cycle (or off-cycle if the impact is large) the agent may also refresh the models with the new variables incorporated to identify the scope of improvements and incorporate the new inputs as appropriate. Advanced agents may then look at opportunities to further refine the models and improve the overall performance through better algorithms and newer data/methodologies (Scripts).

FIG. 15 depicts a data flow view of an exemplary visualization and modeling system variable selection interface design. In the example depicted by FIG. 15, a user performs a query to score a variable presented in a visual query interface providing selections including a variable list and operator list. In the depicted example, the user constructs a query to score a variable by selecting operators from the operator list and also selecting variables from the variable list. The user may also employ the depicted text interface for complex queries. In the depicted example, the user modifies the variable definition through the depicted visual interface. In the illustrated example, the depicted VarMetrix implementation scores the variable on data, creates visualization and performance metrics, and saves the variable.

Although various embodiments have been described with reference to the Figures, other embodiments are possible. For example, some embodiment implementations may provide a Collaborative Pattern Recognition System. In an illustrative example, various embodiment designs may advantageously provide a collaborative, scalable, and accurate pattern detection system to detect fraud, compliance violations and money laundering. Some embodiments may provide a system to better search, organize, access and develop variables. Various embodiment designs may provide a system for analysts to add their insights into the decision process. Some embodiment implementations may provide a system for dynamic pattern detection through automatic feedback of case information. In an illustrative example, various embodiment designs may provide an easy interface configured to permit people of different skills to translate their insights into variables. Some embodiments may provide an easy interface for people of different skills to encode their insights into variables. Some embodiments may enable automated logic and variable development from data, to identify patterns, or define segments of interest. Various embodiment implementations may enable the creation of new generations of algorithms for more accurate, real time and scalable pattern detection. Various embodiment design examples may enable dynamic variable and pattern creation, to be used for driving models that adapt to changing fraud and other patterns. Some embodiment designs may provide algorithms to identify patterns on graphs and using variables generated on a graph. Some embodiment implementation examples may provide an interface to create graphical relationships for analysis. Various embodiments may provide a library of predictive variables for fraud detection. In some embodiment designs, a library of predictive rules to identify specific types of patterns for fraud detection may be provided. Some exemplary embodiment designs may provide a library of predictive models to identify specific types of patterns for fraud detection. In various exemplary embodiment implementations, a library of predictive variables for detection of compliance violations and money laundering may be provided. Various embodiment design examples may provide a library of predictive rules to identify specific types of patterns for detection of compliance violations and money laundering. Some embodiment designs may provide a library of predictive models to identify specific types of patterns for detection of compliance violations and money laundering.

Various embodiments may provide improved Fraud Detection. In some embodiments, improved Compliance Verification may be provided. In some scenarios exemplary of prior art usage, prior art fraud detection may be backward looking, for example, at transactions that have been flagged as fraudulent by victims reporting fraud in their account statement. In such prior art fraud detection examples, after victims report fraud in their account statement and the historical transactions are flagged, a detection model may be changed, however this is too late to protect potential victims, in part because threats are always evolving. In some embodiment examples of the invention disclosed herein, fraud usually has a very small sample size. In various embodiment examples, agents create variables that drive the model. Some embodiments provide agents visual tools to create variables, test, and evaluate models to detect anomalous transactions, in a semi-supervised machine-learning-based collaborative detection system. In various embodiment examples, such a semi-supervised machine-learning-based collaborative detection system may focus on more recent samples, in contrast to prior art systems, which may be constrained to delayed adaptation to new threats based on older samples, leaving potential victims exposed. Various embodiment designs may include library support enhancing anomaly-detection-based fraud detection and compliance violation detection. In some embodiments, an agent may construct an augmented detection model based on variables selected from various embodiment query interface implementations.

In an illustrative example, one of the biggest predictor variables is past response, and timing dependence. In some examples, real-time sales transactions may be detected as anomalous and identified as fraudulent based on a predictive analytic model configured to detect temporal transaction aspects. For example, in various embodiment examples, a newly issued airline card that has been in operation only a few weeks may trigger an alert, based on a model configured with a rule generated by a human expert analyst to detect transactions using new airline cards. In some exemplary embodiments, as soon as a fraud attack happens, a human expert analyst may use an embodiment anomalous transaction modeling and visualization system to highlight unusual events in a limited number of transactions, for example, perhaps five thousand out of one hundred thousand. In such an embodiment implementation, an agent can see the transaction and analyze fraud/not fraud. Various embodiment example agent interfaces allow an agent to quickly enhance models with new rules created to identify anomalous transactions and deploy the enhanced model to monitor a live transaction stream. Various example embodiments may catch more fraud early, based on quickly updating models with new rules. Some example embodiments may be able to detect fraud early, before users report fraud, in contrast with some prior art methodologies, which can take up to four to six weeks before models are updated in response to account holders reporting fraud after viewing their account statements. Various exemplary embodiments use front line information that is being thrown away by prior art methodologies. In addition, some embodiments also provide an interface to agents to quickly enhance models with new rules created to identify anomalous transactions and deploy the enhanced model to monitor a live transaction stream. Some embodiment designs may enforce payments compliance with basic early detection, to identify compliance violations including, for example, money laundering, or terrorist financing. Some embodiment implementations may also monitor and enforce payment compliance, in use cases including the perpetrator desiring to steal a credit card and take funds, and a related use case in which the perpetrator desires to disguise their identity, buy a prepaid card, steal a victim's identity, add the prepaid card to the victim's account, and make a payment from the victim's account with the prepaid card, using the victim's account as a front for the fraudulent payment by the perpetrator. This type of fraud is rarely detected by prior art methodologies, however various disclosed collaborative anomaly detection embodiments may detect such a crime early, potentially limiting damage to the victim's reputation.

In the Summary above and in this Detailed Description, and the Claims below, and in the accompanying drawings, reference is made to particular features of various embodiments of the invention. It is to be understood that the disclosure of embodiments of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In various embodiments. elements described herein as coupled or connected may have an effectual relationship realizable by a direct connection or indirectly with one or more other intervening elements.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting.

In the present disclosure, all embodiments where “comprising” is used may have as alternatives “consisting essentially of,” or “consisting of.” In the present disclosure, any method or apparatus embodiment may be devoid of one or more process steps or components. In the present disclosure, embodiments employing negative limitations are expressly disclosed and considered a part of this disclosure.

Certain terminology and derivations thereof may be used in the present disclosure for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an embodiment “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number),” this means a range whose limit is the second number. For example, 25 to 100 mm means a range whose lower limit is 25 mm and upper limit is 100 mm.

Many suitable methods and corresponding materials to make each of the individual parts of embodiment apparatus are known in the art. According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as may be described herein-above may be used. Many suitable materials are known and available and can be selected and mixed depending on desired strength and flexibility, preferred manufacturing method and particular use, as will be apparent to a person of ordinary skill in the art.

Any element in a claim herein that does not explicitly state “means for” performing a specified function, or “step for” performing a specific function, is not to be interpreted as a “means” or “step” clause as specified in 35 U.S.C. § 112 (f). Specifically, any use of “step of” in the claims herein is not intended to invoke the provisions of 35 U.S.C. § 112 (f).

According to an embodiment of the present invention, the system and method may be accomplished through the use of one or more computing devices. As depicted, for example, at least in FIG. 1, FIG. 2, FIG. 3, FIG. 4, and FIG. 14, one of ordinary skill in the art would appreciate that an exemplary system appropriate for use with embodiments in accordance with the present application may generally include one or more of a Central processing Unit (CPU), Random Access Memory (RAM), a storage medium (e.g., hard disk drive, solid state drive, flash memory, cloud storage), an operating system (OS), one or more application software, a display element, one or more communications means, or one or more input/output devices/means. Examples of computing devices usable with embodiments of the present invention include, but are not limited to, proprietary computing devices, personal computers, mobile computing devices, tablet PCs, mini-PCs, servers or any combination thereof. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In various embodiments, communications means, data store(s), processor(s), or memory may interact with other components on the computing device, in order to effect the provisioning and display of various functionalities associated with the system and method detailed herein. One of ordinary skill in the art would appreciate that there are numerous configurations that could be utilized with embodiments of the present invention, and embodiments of the present invention are contemplated for use with any appropriate configuration.

According to an embodiment of the present invention, the communications means of the system may be, for instance, any means for communicating data over one or more networks or to one or more peripheral devices attached to the system. Appropriate communications means may include, but are not limited to, circuitry and control systems for providing wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description may set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a sequence of computational instructions or program instructions. It will be appreciated that a programmable apparatus (i.e., computing device) can receive such a computer program and, by processing the computational instructions thereof, produce a further technical effect.

A programmable apparatus may include one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. An apparatus, comprising:
a collaborative pattern recognition module configured to detect anomalies with a transaction classifying action augmented with expert criteria in response to an erroneous classification, comprising:
a processor; and,
a memory that is not a transitory propagating signal, the memory operably coupled with the processor and encoding computer readable instructions, including processor executable program instructions, the computer readable instructions accessible to the processor, wherein the processor executable program instructions, when executed by the processor, cause the processor to perform operations comprising:
classify a transaction as anomalous or not anomalous as a function of a predictive analytic model configured to detect anomalies;
generate a rule based on expert analysis of a limited number of data samples to classify as anomalous a transaction erroneously classified as not anomalous;
augment the predictive analytic model with the generated rule; and,
deploy the augmented predictive analytic model to automatically identify an attack early based on classifying as anomalous a transaction matching the generated rule in a live transaction stream.

2. The apparatus of claim 1, wherein classify a transaction as anomalous or not anomalous further comprises clustering.

3. The apparatus of claim 1, wherein the predictive analytic model further comprises a decision tree.

4. The apparatus of claim 1, wherein the predictive analytic model further comprises a neural network or other non-linear model.

5. The apparatus of claim 1, wherein the predictive analytic model further comprises an ensemble model.

6. The apparatus of claim 1, wherein the predictive analytic model further comprises a regression model.

7. The apparatus of claim 1, wherein classify a transaction as anomalous or not anomalous as a function of a predictive analytic model configured to detect anomalies further comprises calculating a classification score determined as a function of the transaction and the predictive analytic model.

8. The apparatus of claim 7, wherein the operations performed by the processor further comprise classifying a transaction as anomalous based on a determination the classification score is greater than or equal to a predetermined minimum classification score.

9. The apparatus of claim 7, wherein the operations performed by the processor further comprise classifying a transaction as not anomalous based on a determination the classification score is less than a predetermined maximum classification score.

10. The apparatus of claim 1, wherein generate a rule based on expert analysis further comprises generating a rule based on transaction criteria comprising a compliance violation.

11. The apparatus of claim 1, wherein generate a rule based on expert analysis further comprises generating a rule based on transaction criteria selected by a human expert from a visually perceptible transaction representation displayed in a graphical user interface.

12. A process, comprising:
a method to identify an attack early using a limited number of data samples, comprising:
classifying a transaction as anomalous or not anomalous as a function of a predictive analytic model configured to detect anomalies;
generating a rule based on expert analysis of a limited number of data samples to classify as anomalous a transaction erroneously classified as not anomalous;
augmenting the predictive analytic model with the generated rule; and,
deploying the augmented predictive analytic model to automatically identify an attack early based on classifying as anomalous a transaction matching the generated rule in a live transaction stream.

13. The process of claim 12, wherein classifying a transaction as anomalous or not anomalous further comprises clustering.

14. The process of claim 12, wherein the predictive analytic model further comprises a decision tree.

15. The process of claim 12, wherein the predictive analytic model further comprises an ensemble model.

16. The process of claim 12, wherein the predictive analytic model further comprises a regression model.

17. The process of claim 12, wherein classifying a transaction as anomalous or not anomalous as a function of a predictive analytic model configured to detect anomalies further comprises calculating a classification score determined as a function of the transaction and the predictive analytic model.

18. The process of claim 17, wherein classifying a transaction as anomalous or not anomalous further comprises classifying a transaction as anomalous based on a determination the classification score is greater than or equal to a predetermined minimum classification score.

19. The process of claim 17, wherein classifying a transaction as anomalous or not anomalous further comprises classifying a transaction as not anomalous based on a determination the classification score is less than a predetermined maximum classification score.

20. The process of claim 12, wherein generating a rule based on expert analysis further comprises generating a rule based on transaction criteria comprising a compliance violation.

21. The process of claim 12, wherein generating a rule based on expert analysis further comprises generating a rule based on transaction criteria selected by a human expert from a visually perceptible transaction representation displayed in a graphical user interface.
